(19) United States
(12) Patent Application Publication
(10) Pub. No.: US 2013/0044209 A1
(43) Pub. Date: Feb. 21, 2013

(54) APPARATUS AND METHOD FOR DETECTING THE SURFACE DEFECT OF THE GLASS SUBSTRATE

(71) Applicants: Gyuhong HWANG, Asan-si (KR); Taeho KEEM, Asan-si (KR); Jihwa JUNG, Asan-si (KR); Jaehoon KWON, Asan-si (KR); Mark KEMMANN, Hamburg (DE); Marko VOITEL, Hamburg (DE); Erik LOHSE, Hoisdorf (DE); Andreas BOCK, Hamburg (DE)

(72) Inventors: Gyuhong HWANG, Asan-si (KR); Taeho KEEM, Asan-si (KR); Jihwa JUNG, Asan-si (KR); Jaehoon KWON, Asan-si (KR); Mark KEMMANN, Hamburg (DE); Marko VOITEL, Hamburg (DE); Erik LOHSE, Hoisdorf (DE); Andreas BOCK, Hamburg (DE)

(73) Assignee: SAMSUNG CORNING PRECISION MATERIALS CO., LTD., Gumi-si (KR)

(21) Appl. No.: 13/251,831

(22) Filed: Oct. 3, 2011

(30) Foreign Application Priority Data
Aug. 18, 2011 (KR) 10-2011-0082380

(51) Int. Cl. H04N 7/18

(52) U.S. Cl. 348/128; 348/E07.085

(57) ABSTRACT

The apparatus for detecting surface defects of a glass substrate, having a dark field optical system, includes: a first photographing device for photographing first image; a second photographing for photographing second image; a dark field illumination system disposed below the glass substrate for serving as a dark field illumination; and a detection signal processor operating coordinates of a defect position on the first image and the second image, wherein the first photographing device and the second photographing device form photographing areas in the shape of lines which are not parallel to at least the transferring direction of the glass substrate, form photographing areas for a top surface of the glass substrate to be overlapped by each other and form photographing areas for a bottom surface of the glass substrate differently from each other.

### BACKGROUND OF THE INVENTION

1. Field of the Invention

The present invention relates to an apparatus and method for detecting surface defects of a glass substrate, and more particularly, to an apparatus for detecting surface defects of a glass substrate in which two images are obtained via two photographing devices and A/B surfaces of surface defects according to the difference in length of surface defects displayed in the respective images, and a method thereof.

2. Description of the Related Art

A glass substrate used in a flat panel display is deposited with a micro circuit pattern only on one surface thereof which is called a ‘the surface A’ in the glass industry and is not deposited with a micro circuit pattern on the other surface thereof which is called a ‘the surface B’ in the glass industry.

When defects are present on the surface A of the glass substrate, if the micro circuit pattern is deposited over the defects, a defective proportion of the micro circuit pattern is likely to increase. Therefore, it is necessary to precisely detect whether defects are present on the glass substrate (specifically, the surface A on which the micro circuit pattern is to be deposited) before depositing the micro circuit pattern. For reference, the term “defects” used hereinafter means various types of surface defects such as the generation of scratches, dirt adhering, surface protrusion, foam generation or the like.

As for an inspection device for detecting defects on a transparent plate-shaped body, BF (Bright Field) optical systems and DF (Dark Field) optical systems are widely employed. The present invention is related to apparatus and method for detecting the surface defect of the glass substrate using DF (Dark Field) optical systems.

A dark field optical system will be described briefly as follows. FIG. 1 shows a dark field optical system for detecting defects which exist on a transparent plate-shaped body. Referring to FIG. 1, in a dark field optical system, a sensor camera 5 is disposed on a top surface of a transparent plate-shaped body 1, and a light source 6 is disposed on a bottom surface of the transparent plate-shaped body 1, thereby photographing images by using transmitted light instead of reflected light. In other words, the dark field optical system detects defects 4 such as impurities, scratches or the like which are existing on the transparent plate-shaped body 1 by collecting dark field components in transmitted light beams 7.

The dark field optical system has higher testing power rather than the bright field optical system so that the dark field optical system can detect surface defects of the transparent plate-shaped body precisely and sensitively. The dark field optical system has, however, a limitation in information on the positions of surface defects with respect to surfaces A/B since there is hardly any difference in signals for the defects existing on the surface A and defects existing on the surface B.

In the meantime, a glass substrate used in the flat panel display has a big difference in quality respectively required for surfaces A and B. For example, the surface A is very sensitive to protrusion defects and scratch defects, thereby requiring high quality specifications. To the contrary, the surface B is insensitive, requiring low quality specifications.

When transferring substrates in a glass substrate process, the surface B is brought into contact with a transferring means, so that fine scratches can be formed on the surface B and cause impurities to be adhered to the surface B. However, such defects are allowable on the surface B due to the low quality specifications of the surface B.

If such defects were generated on the surface A, the corresponding glass substrate is sorted as “NG” and not allowed to be used in the manufacture of a flat panel display. Therefore, it is favorable to use a dark field optical system having high test power and carry out surface defect inspection. In the meantime, the dark field optical system has a disadvantage that it is impossible to distinguish the surfaces A/B from each other. Therefore, the dark field optical system detects the existence of defects excluding the information on the surfaces A/B having the generated infects and provides the simple detection result to an inspector, so that it entirely depends on the manual work of the inspector to distinguish to which surface the defects correspond.

Consequently, even though a certain glass substrate has a surface A with a favorable quality and a surface B with an allowable fine scratches, properly for the manufacture of a panel display, the dark field optical system recognizes the glass substrate as having surface defects and provides defect images to an inspector, so that the inspector has to distinguish to which surface among the surfaces A/B the defect image corresponds. Therefore, the additional step for manual distinguish is further required, decreasing the process yield and workability. In addition, intermittently generated fine scratches on the surface A are wrongfully determined to correspond to the surface B, causing the problem that improper glass substrates are used in mass production.

### SUMMARY OF THE INVENTION

Accordingly, the present invention has been made in an effort to solve the problems occurring in the related art, and an object of the present invention is to provide an apparatus and a method for detecting surface defects of a glass substrate, in which the high test power, the advantage of a dark field optical system may be secured as well as A/B surface distinguish function, so that a cycle time required for the distinguish of surfaces A/B for surface defects is reduced, and an inspector has to inspect surface defects of high NG possibilities only, thereby maximizing inspection engagement.

To accomplish the above object of the present invention, an apparatus for detecting surface defects of a glass substrate, having a dark field optical system, comprises: a first photographing device disposed above a glass substrate for photographing first images of surface defects on the glass substrate; a second photographing device disposed above a glass substrate for photographing second images of the surface defects on the glass substrate; a dark field illumination system disposed below the glass substrate for serving as a dark field illumination penetrating the glass substrate towards the first photographing device and the second photographing device; and a detection signal processor operating coordinates of a defect position on the first image and coordinates of a defect position on the second image; wherein the first photographing device and the second photographing device form photographing areas in the shape of lines which are not parallel to at least the transferring direction of the glass substrate, form photographing areas for a top surface of the glass substrate to be overlapped by each other and form photographing areas for a bottom surface of the glass substrate differently from each other.

Further, a method for detecting surface defects of a glass substrate, comprises the steps of: generating a third image by synthesizing a obtained by a first photographing device and a second image obtained by a second photographing; and distinguishing on which surface the surface defects are generated according to a difference in a distance formed by the defects corresponding to the first image and the defects corresponding to the second image in the third image.

According to the apparatus for detecting surface defects of a glass substrate, the high test power as the advantage of the dark field optical system may be secured and simultaneously it is possible to distinguish on which surface the surface defects are generated, thereby exhibiting effects as follows.

(1) It is possible to filter a large amount of surface defects which are generated on the surface B easily in short time, so that the inspection load of an inspector may be reduced and process efficiency may be increased.

(2) The precision and engagement of inspection work for surface defects generated on the surface A may be improved since the amount of images to inspect is reduced, so that the use of improper glass substrates in mass production may be fully prevented.

(3) A warranty level of a glass substrate product may be increased since the information on the positions of fine surface defects may be obtained.

### BRIEF DESCRIPTION OF THE DRAWINGS

FIG. 1 is a view showing a conventional dark field optical system for detecting defects present on a transparent plate-shaped body.

FIG. 2 is a constructional view showing the structure of an apparatus for detecting surface defects of a glass substrate according to the present invention.

FIG. 3 is a side view of the apparatus for detecting surface defects of a glass substrate according to the present invention of FIG. 2.

FIG. 4 is an example view showing a misarrangement state of first and second photographing devices according to the present invention.

FIG. 5(a) and FIG. 5(b) are side views respectively showing various arrangement shapes of the first and second photographing devices according to the present invention.

FIG. 6 is a side view showing a most preferred arrangement shape of the first and second photographing devices according to the present invention.

FIG. 7a is an explanatory view for describing a method for detecting surface defects generated on a top surface of a glass substrate according to an apparatus for detecting surface defects of a glass substrate of the present invention.

FIG. 7b shows experimental data for showing first and second images obtained in the process of inspection of FIG. 7a.

FIG. 8a is an explanatory view for describing a method for detecting surface defects generated on a bottom surface of a glass substrate according to an apparatus for detecting surface defects of a glass substrate of the present invention.

FIG. 8b shows experimental data for showing first and second images obtained in the process of inspection of FIG. 8a.

FIG. 9 is a constructional view of an apparatus for detecting surface defect of a glass substrate according to one embodiment of the present invention.

FIG. 10 is a side view of FIG. 9.

FIG. 11 is a side view of a modification of the apparatus for detecting surface defect of a glass substrate, in which positions of photographing devices of FIG. 9 are changed.

FIG. 12 is a side view of the apparatus with a width (Φ) of light pathway set equal to a thickness (t) of a glass substrate when a dark field illumination system illuminates the glass substrate under the same condition as in FIG. 10.

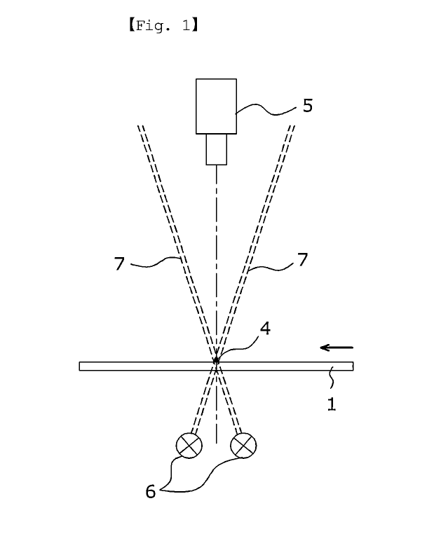

### BRIEF EXPLANATION OF REFERENCE SYMBOLS

1: glass substrate 8, 9: surface defects
10: first photographing device
20: second photographing device
30: illumination system 40: detection signal processor
P1: photographing areas of first and second photographing device
P2: photographing area of second photographing device
P3: photographing area of first photographing device

### DETAILED DESCRIPTION OF PREFERRED EMBODIMENTS

Reference will now be made in greater detail to preferred embodiments of an apparatus for detecting surface defects of a glass substrate according to the invention, examples of which are illustrated in the accompanying drawings. Wherever possible, the same reference numerals will be used throughout the drawings and the description to refer to the same or like parts.

The present invention has a technical aspect to realize an advantage of a bright field optical system capable of distinguishing surfaces A/B while ensuring an advantage of a dark field optical system having high test power, all by means of an apparatus for detecting surface defects of a glass substrate, which is formed in a dual camera structure.

Hereinafter, preferred embodiments of an apparatus for detecting surface defects of a glass substrate according to the invention will be described in more detail together with advantages and characteristics thereof with reference to the accompanying drawings.

Before explanation, the term ‘transferring direction Y’ used hereinafter is defined to indicate the advancing direction of a glass substrate which is transferred via a transferring means, ‘width direction x’ is defined to indicate the direction parallel to the width of the glass substrate and is perpendicular to the transferring direction Y. Further, the term “surface defects” used hereinafter is defined to include scratches generated on the surface of a glass substrate and impurities adhered to the surface as well as surface defects in various shapes such as fine protrusions of the surface due to flaws in a glass manufacturing process

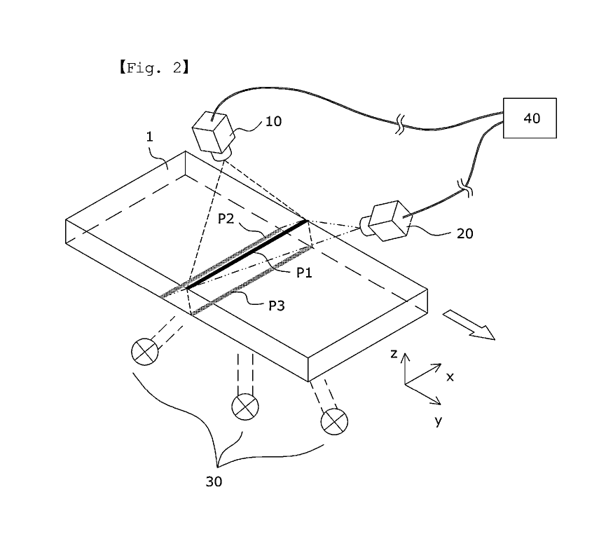

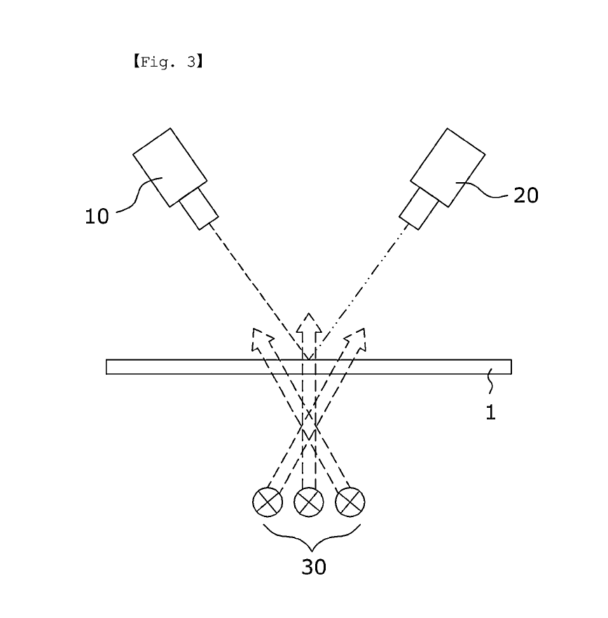

FIG. 2 is a constructional view showing the basic structure of an apparatus for detecting surface defects of a glass substrate according to the present invention, and FIG. 3 is a side view of FIG. 2.

Referring to FIG. 2 and FIG. 3, an apparatus for detecting surface defects of a glass substrate according to the present invention includes at least two photographing devices, a dark field illumination system 30 for irradiating light towards the photographing devices, and a detection signal processor 40 for receiving image signals inputted from the photographing devices.

A glass substrate 1 corresponding to an object to inspect in the present invention is a substrate made of a thin glass material used for a panel of a flat panel display device such as an LCD and a PDP, being generally formed in a thickness of 0.5 mm to 0.7 mm, wherein a ‘surface A’ means a surface to be deposited with a micro circuit pattern, while a ‘surface B’ indicates a surface where the micro circuit pattern is not formed. Reference symbols ‘P1, P2 and P3’ indicate photographing areas (scanning areas) by the photographing devices.

The photographing device according to the present invention is a machine for continuously photographing the glass substrate 1 which is transferred via a transferring roller or the like so as to obtain image information for a corresponding substrate surface and then transmit image signals to a detection signal processor 40.

The photographing device as above is preferably made of a CCD (Charge-coupled device) type sensor camera which provides image information on a surface of a corresponding glass substrate 1 by converting incident light to electric signals, but not limited thereto.

The apparatus for detecting surface defects of a glass substrate according to the invention is characterized in that at least two or more of the photographing device are provided and such a plurality of photographing devices is disposed along the transferring direction Y of the glass substrate. According to a preferred embodiment of the invention as shown in FIG. 2 and FIG. 3, an apparatus for detecting surface defects of a glass substrate comprises two photographing devices, which are hereinafter respectively indicated as a first photographing device 10 and a second photographing device 20, so that an image of the surface of a glass substrate 1 which is photographed by the first photographing device 10 is indicated as a first image and an image of the surface of a glass substrate 2 which is photographed by the second photographing device 20 is indicated as a second image.

According to a preferred embodiment as shown in FIG. 2, all the first photographing device 10 and the second photographing device 20 are mounted above the glass substrate 1 at a first angle θ1 and a second angle θ2 respectively one by one along the transferring direction Y, wherein the first photographing device 10 and the second photographing device 20 form photographing areas in the shape of lines which are not parallel to at least the transferring direction of the glass substrate 1.

For reference, the first angle θ1 means an angle formed by the first photographing device 10 with respect to a normal vector V1 of the photographing area for a top surface of the glass substrate 1, and the second angle θ2 means an angle formed by the second photographing device 20 with respect to the same normal vector.

The first and second photographing devices of the present invention continuously photograph the surfaces of the glass substrate in the line scan manner with sensors having pixels disposed in the traverse direction only. That is, the pixels composing the sensors of the photographing devices are disposed crossing over the width of the glass substrate so that the first and second photographing devices form photographing areas P1, P2 and P3 in the shape of lines which cross over the width of the glass surfaces in parallel or obliquely. Further, the width of the glass substrate 1 is included in the ranges of lines of the photographing areas P1, P2 and P3, so that an exhaustive inspection may be carried out over the entire surfaces of the glass substrate 1 without

According to one aspect of the present invention, the photographing areas (scanning areas) formed by the first photographing device 10 and the second photographing device 20 on a top surface (surface A) of the glass substrate are overlapped by each other and the photographing areas (scanning areas) on a bottom surface (surface B) of the glass substrate are different from each other.

Therefore, if the apparatus for detecting surface defects of a glass substrate according to the invention comprises two photographing devices, the three photographing areas P1, P2 and P3 are formed, wherein symbol ‘P1’ corresponds to the photographing areas of the first photographing device 10 and the second photographing device 20 for the defects on the top surface of the glass substrate 1, which are overlapped each other, symbol ‘P2’ corresponds to the photographing areas of the second photographing device 20 for the defects on the bottom surface of the glass substrate 1, that is, the photographing areas native to the second photographing device 20, and symbol ‘P3’ corresponds to the photographing areas of the first photographing device 10 for the defects on the bottom surface of the glass substrate 1, that is, the photographing areas native to the first photographing device 10. According to the preferred embodiment as shown in FIG. 2, the first and second photographing devices 10, 20 are disposed above the glass substrate 1 in the transferring direction Y of the glass substrate 1 so as to scan the same area on the glass substrate 1. Therefore, the photographing areas (P1: scanning lines) formed by the first photographing device 10 on the top surface (surface A) of the substrate and the photographing areas (P2) formed by the second photographing device 20 on the top surface (surface A) of the substrate are overlapped by each other.

However, the photographing device 10 and the second photographing device 20 are disposed to focus the same points, wherein the photographing device 10 and the second photographing device 20 should be positioned not to be at the same angle in the same direction with respect to the normal vector V1 of at least the ‘P1’ photographing areas of the glass surface.

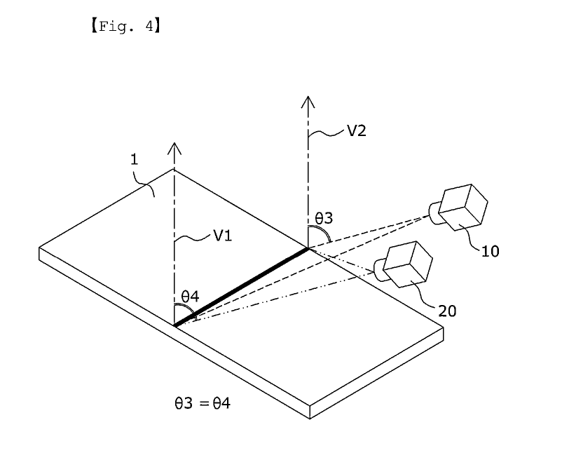

For example, referring to FIG. 4, the first photographing device 10 and the second photographing device 20 are disposed to scan the same areas on the surface (surface A) of the glass substrate, wherein the photographing device 10 and the second photographing device 20 are disposed at the same angle (θ3=θ4) in the same direction with respect to the normal vector V1 of the ‘P1’ photographing areas, which is a wrongful structure.

This is for the first photographing device 10 and the second photographing device 20 of the present invention to have the photographing areas with respect to the same points of the top surface of the glass substrate but to have the photographing areas with respect to the different points of the bottom surface of the glass substrate, realizing the function for distinguishing the surfaces A/B for the surface defects by the technical feature.

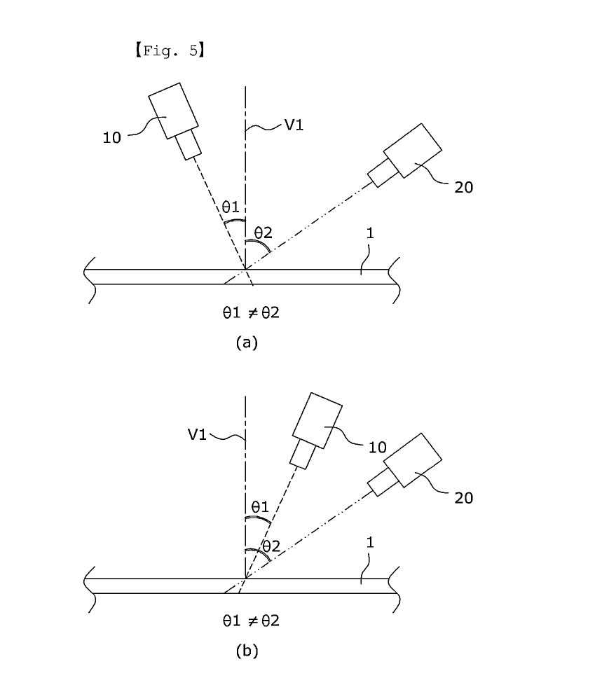

FIG. 5 shows side views of various dispositions of the first photographing device 10 and the second photographing device 20, wherein, referring to FIG. 5(a), the first photographing device 10 and the second photographing device 20 are configured to scan the same points P1 for the top surface of the glass substrate, but be inclined in different directions (left and right directions) at different angles (θ1≠θ2) with respect to the normal vector V1 of the photographing areas P1 of the glass substrate. Referring to FIG. 5, the first photographing device 10 and the second photographing device 20 are configured to scan the same points for the top surface of the glass substrate, but be inclined in the same direction (right direction) at different angles (θ1≠θ2) with respect to the normal vector V1 of the photographing areas P1 of the glass substrate.

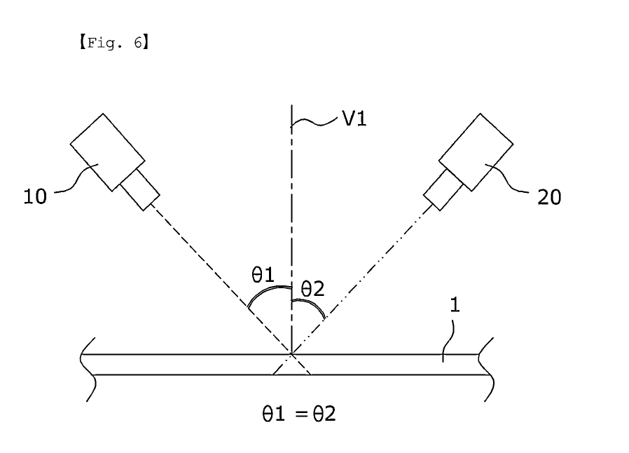

By the configuration as shown in FIG. 5, the first photographing device 10 and the second photographing device 20 of the present invention have the same photographing areas for the top surface of the glass substrate, wherein the first angle θ1 of the first photographing device 10 and the second angle θ2 of the second photographing device 20 are different from each other at least in the same direction with respect to the normal vector V1 so as to have photographing areas different each other with respect to the bottom surface of the glass substrate. FIG. 6 is a side view showing a most preferred disposition shape of the first photographing device 10 and the second photographing device 20 according to the present invention. An apparatus for detecting surface defects of a glass substrate according to the most preferred embodiment of the present invention will be described in more detail with reference to FIG. 6. The first photographing device 10 and the second photographing device 20 are configured to scan the same points P1 for the top surface of the glass substrate and disposed symmetrically in the right and left directions with respect to the normal vector V1 so as to form the first angle θ1 and the second angle θ2, which are equal to each other. Further, the first photographing device 10 and the second photographing device 20 are configured to cross over the width of the glass substrate by the photographing areas in the line shape, more preferably to be in parallel to the width of the glass substrate, wherein the first and second photographing devices are preferably disposed on the central axis of the glass substrate.

A dark illumination system 30 of the present invention is disposed below the glass substrate so as to serve as a dark field illumination penetrating the glass substrate towards the first photographing device 10 and the second photographing device 20, wherein the first photographing device 10 and the second photographing device 20 photograph images of the surface defects by transmitted light. That is, according to the apparatus for detecting surface defects of a glass substrate according to the present invention, defects existing on the glass surface are detected by collecting dark field components in the light transmitting the transparent glass substrate.

Therefore, even though the number of the dark field illumination system 30 to be mounted is not important, the illumination projected from the dark field illumination system 30 has to be configured to light at least the photographing area P1, which are formed on the top surface of the glass substrate, and the two photographing areas P2 and P3, which are formed on the bottom surface of the glass substrate, all of them exhaustively. One example of the illumination system 30 includes a line lighting system which uses an optical fiber to allow light emitted from several halogen lamps or laser sources to pass through a glass substrate in a width direction of the glass substrate.

As described hereinabove, the dark filed illumination system 30 of the present invention serve as a dark field illumination for the first photographing device 10 and the second photographing device 20, wherein it is preferable to form relative angles applied to the respective photographing devices as equally as possible.

According to the apparatus for detecting surface defects of a glass substrate of the present invention as described hereinabove, two images (that is, the first image obtained by the first photographing device and the second image obtained by the second photographing device 20) may be obtained with respect to the same surface defects, wherein defects on the first image and the defects on the second image are displayed at coordinates which are equal to each other or hardly with an error with each other if corresponding surface defects exist on the top surface (surface A) of a glass substrate and, in the meantime, defects on the first image and the defects on the second image are displayed at coordinates which are largely different from each other so that it becomes possible to distinguish on which surface the surface defects are generated if corresponding surface defects exist on the bottom surface (surface B) of the glass substrate.

A detection signal processor 40 of the present invention receives two image information (first image information and second image information) input for the same surface defects, so that the coordinates of the position of the defects on the first image and the coordinates of the position of the defects on the second image are operated, thereby extracting positional information of corresponding defects.

Further, the detection signal processor 40 of the present invention synthesizes a third image reflecting the difference of distance between the defects on the first image and the defects on the second image on the basis of the extracted positional coordinates and outputs the synthesis result to a display unit, so that an inspector can visually recognize the degree of separation formed by two real images and easily distinguish on which surface the surface defects are generated in a short time.

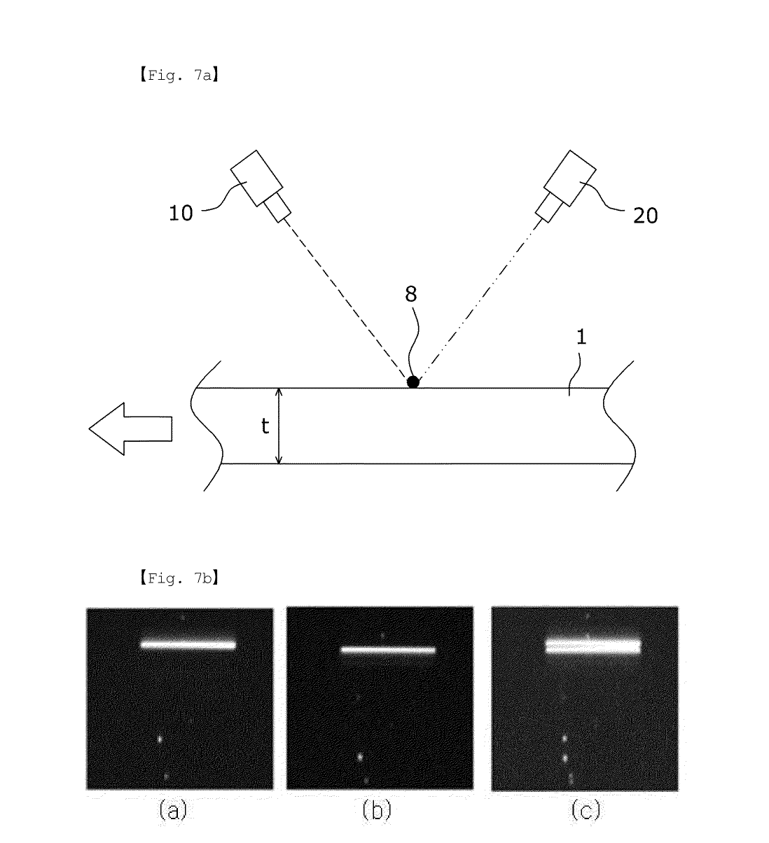

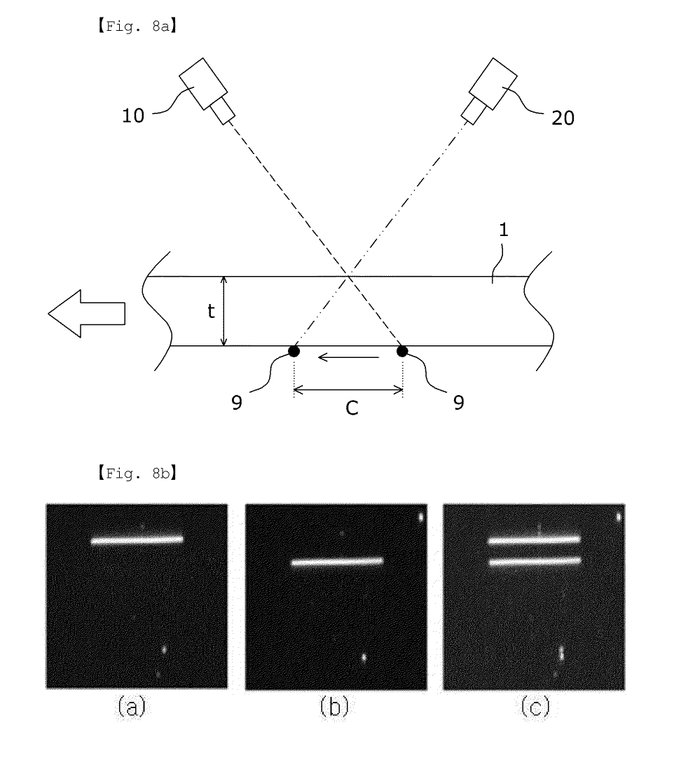

FIG. 7a is an explanatory view for describing a method for detecting surface defects generated on a top surface of a glass substrate according to an apparatus for detecting surface defects of a glass substrate of the present invention, and FIG. 7b shows experimental data for showing first and second images obtained in the process of inspection of FIG. 7a. FIG. 8a is an explanatory view for describing a method for detecting surface defects generated on a bottom surface of a glass substrate according to an apparatus for detecting surface defects of a glass substrate of the present invention, and FIG. 8b shows experimental data for showing first and second images obtained in the process of inspection of FIG. 8a.

Now, a method for distinguish on which surface among surface A and surface B the surface defects of a glass substrate are generated in more detail with reference to FIG. 7a to FIG. 8b. For reference, it is assumed that the top surface of the glass substrate as shown in FIG. 7a and FIG. 8a is the ‘surface A’ and the bottom surface thereof is the ‘surface B’. Reference symbols ‘8’ and ‘9’ correspond to defects (scratches and impurities) generated on the surface of the glass surface. Further, the glass substrate, which is used in the experiments of FIG. 7b and FIG. 8b, has a thickness t of about 700 μm.

(1) In the Case that Defects 8 Exist on the Surface A

As particular defects 8 (scratches and impurities) generated on the top surface of a glass substrate are transferred together with the glass substrate and advance into the range of the photographing areas P1 as shown in FIG. 2, then the first photographing device 10 and the second photographing device 20 capture images on the particular defects 8 simultaneously (that is, without any time interval) so as to generate a first image and a second image respectively. This is caused by the fact that the first photographing device 10 and the second photographing device 20 have the same photographing areas P1 for the top surface (surface A) of the glass substrate as shown in FIG. 2.

FIG. 7b shows screens of first images (FIG. 7a) and second images (FIG. 7b) generated by the first and second photographing devices capturing defects simultaneously. As shown in FIG. 7b, as for the surface defects 8 existing on the top surface of the glass substrate, there is almost no time interval between a time point photographed by the first photographing device 10 and a time point photographed by the second photographing device 20, so that the coordinates of the defects detected on the first image and the coordinates of the defects detected on the second image have almost the same values.

Therefore, if a third image is formed by synthesizing the first image (FIG. 7b(a)) and the second image (FIG. 7b(b)), the surface defects on the first image and the surface defects on the second image appear overlapped by each other without any interval therebetween as shown in FIG. 7b(c).

(2) In the Case that Defects 9 Exist on the Surface B

If particular defects 9 (scratches and impurities) exist on the bottom surface of a glass substrate, the defects 9 advance into the photographing area P3 of the first photographing device 10 and then the photographing area P2 of the second photographing device 20 with a temporal difference in sequence, differently from the case that the defects exist on the top surface of the glass substrate.

As shown in FIG. 8a, if the glass substrate moves from the right side to the left side, the surface defects 9 existing on the bottom surface of the glass substrate first reach the photographing area P3 of the first photographing device 10 to be captured, thereby generating the first image.

After that, if the glass substrate moves by a distance C of about 200 μm, it advances into the photographing area P2 of the second photographing device 20 to be captured, thereby generating the second image.

By the same reason, the coordinates of the defects detected on the first image (FIG. 8b(a)) and the coordinates of the defects detected on the second image (FIG. 8b(b)) have different values.

Therefore, if a third image is formed by synthesizing the first image (FIG. 8b(a)) and the second image (FIG. 8b(b)), the surface defects on the first image and the surface defects on the second image appear with a predetermined difference of distance from each other therebetween as shown in FIG. 8b(c).

As described hereinabove, according to the apparatus for detecting surface defects of a glass substrate of the present invention, the synthesized image in the case that the defects exist on the surface A and the synthesized image in the case that the defects exist on the surface B appear in different shapes.

In other words, a synthesized image (third image) is provided with corresponding defects appeared in the overlapped shape if the defects existing on the surface A are detected, while a synthesized image (third image) is provided with corresponding defects appeared in the shape separated from each other by a predetermined interval if the defects existing on the surface B are detected.

This is caused by the fact that the defects on the surface A are displayed at the same coordinates on the first image of the first photographing device 10 and the second image of the second photographing device 20, while the defects on the surface B are displayed at coordinates different from each other on the first image and the second image.

Therefore, the surface among the surfaces A/B of the glass substrate, on which the surface defects exist, is distinguished as follows.

First, the coordinates of the position of the defects on the first image and the coordinates of the position of the defects on the second image are extracted. And then, on the basis of the extracted positional coordinates, a third image is generated by synthesizing the first image and the second image. Next, in the third image, the surface on which the surface defects are generated is distinguished via the difference of distance formed by the defects corresponding to the first image and the defects corresponding to the second image. At this point, if the defects corresponding to the first image and the defects corresponding to the second image are overlapped by each other, the defects are determined as the surface defects which are generated on the top surface of the glass substrate. In the mean time, if the defects corresponding to the first image and the defects corresponding to the second image are separated from each other by a predetermined distance difference, the defects are determined as the surface defects which are generated on the bottom surface of the glass substrate.

Or, the surface among the surfaces A/B of the glass substrate, on which the surface defects exist, is distinguished as follows. That is, if the positional coordinates of the defects of the first image and the positional coordinates of the defects of the second image are equal to each other, the defects are determined as the surface defects which are generated on the top surface of the glass substrate. In the mean time, if the positional coordinates of the defects of the first image and the positional coordinates of the defects of the second image are different from each other, the defects are determined as the surface defects which are generated on the bottom surface of the glass substrate.

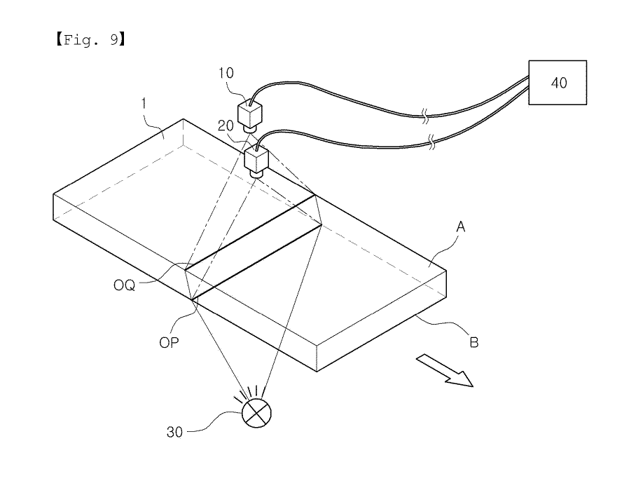

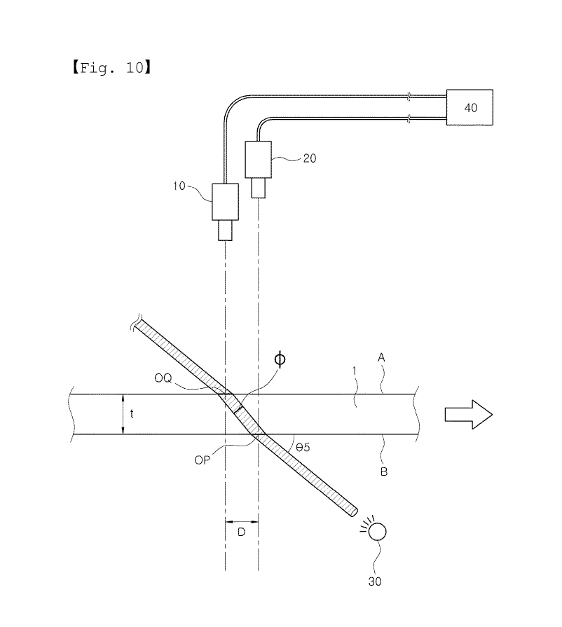

FIG. 9 is a constructional view of an apparatus for detecting surface defect of a glass substrate according to one embodiment of the present invention, and FIG. 10 is a side view of FIG. 9. Next, the apparatus for detecting surface defect of a glass substrate according to this embodiment will be described with reference to FIGS. 9 and 10. The apparatus according to this embodiment includes a dark field illumination system 30 disposed below a glass substrate 1 and emitting light upwards such that the emitted light is incident on an imaginary line (OP) approximately vertical to a transfer direction on a lower surface (B) of the glass substrate 1, refracted in a thickness direction of the glass substrate, and then passes through an imaginary line (OQ) approximately vertical to the transfer direction on an upper surface (A) of the glass substrate 1; a first photographing device 10 photographing an area of the imaginary line (OQ) formed on the upper surface A of the glass substrate 1; a second photographing device 20 photographing an area of the imaginary line (OP) formed on the lower surface B of the glass substrate 1; and a detection signal processor 40 determining which surface foreign matter is attached to among the upper and lower surfaces of the glass substrate 1 by comparing images input from the first and second photographing devices 10, 20.

The dark field illumination system 30 emits light upwards from a point below the lower surface B of the glass substrate 1 towards the upper surface (A) thereof. Here, the dark field illumination system 30 is configured to allow the emitted light to enter the lower surface (B) of the glass substrate 1 through the imaginary line (OP) approximately vertical to the transfer direction, to pass through the glass substrate 1 in the thickness direction thereof, and to exit from the upper surface (A) of the glass substrate 1 through the imaginary line (0Q) approximately vertical to the transfer direction. Actually, when the light emitted from the dark field illumination system 30 strikes the lower surface (B), a substantial amount of the light can be reflected downwards by the lower surface (B) and some of the light passing through the glass substrate 1 can also be reflected by the upper surface (A) of the glass substrate when striking the upper surface (A). Herein, however, a description of such reflection will be omitted for convenience.

Light emitted from the dark field illumination system 30 is radiated to an overall surface of the glass substrate 1 in a width direction at a certain angle (‘90°−θ’ with reference to FIG. 9) with respect to a normal vector of the lower surface (B) of the glass substrate 1. An incident angle (90°−θ) of light with respect to the normal vector of the lower surface (b) may be greater than 45° and less than 85°. As the incident angle of light approaches a right angle with respect to the lower surface of the glass substrate (in the case where the incident angle (90°−θ) of light with respect to the normal vector of the lower surface (b) is 45° or more), the light travels in a decreased horizontal distance (D) from a point where the incident light is refracted by the lower surface in the thickness direction of the glass substrate to a point where the light reaches the upper surface of the glass substrate, thereby making it difficult to determine a surface of the glass substrate to which detected foreign matter is attached, and providing a substantial difficulty installing the photographing devices 10, 20 due to a narrowed distance between the photographing devices 10, 20, even if detected. Herein, the term “horizontal distance (D)” is defined as a horizontal movement distance of light longitudinally moving in the glass substrate 1 from a point at which light is incident on the lower surface (B) of the glass substrate 1 to a point through which the light exits the upper surface (A) of the glass substrate 1. Thus, although the horizontal distance (D) may be advantageously increased by increasing the incident angle of light with respect to the normal vector of the lower surface (B), the amount of light reflected by the lower surface increases with increasing incident angle of light, thereby requiring an increase in output amount of light to obtain the same amount of transmittance. Therefore, the incident angle of light with respect to the normal vector of the lower surface (B) is preferably set to be less than 85° in consideration of the output amount of light. Although this embodiment is illustrated as including a single light source (30) in FIGS. 9 and 10, a plurality of laser sources may be arranged in the width direction of the glass substrate 1.

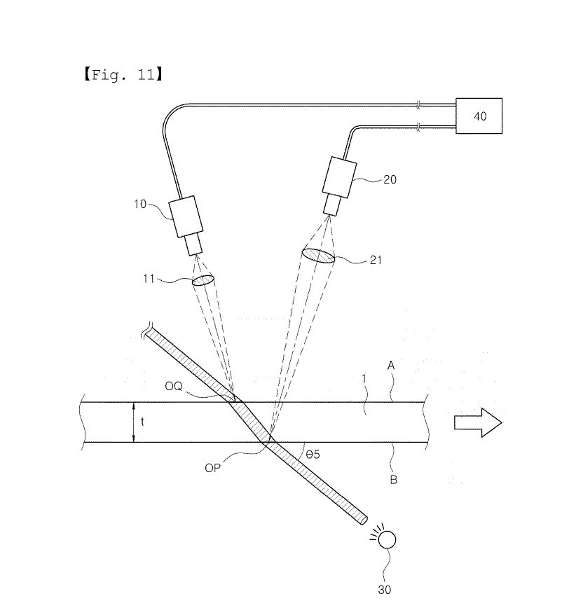

The second photographing device 20 is a device for photographing an area corresponding to the imaginary line (OP) formed on the lower surface (B) of the glass substrate 1 and is disposed above the imaginary line (OP) to be orthogonal thereto. As shown in FIG. 11, since the area photographed by the second photographing device 20 is an area (OP) on the lower surface (B) of the glass substrate 1 to which light is radiated, only scattering caused by foreign matter attached to the lower surface (B) can be photographed by the second photographing device. However, even in the case where foreign matter is attached to an area on the upper surface (A) corresponding to the area on the lower surface (B), scattering caused by the foreign matter attached to the upper surface (A) is not photographed or provides a very dim image, which can be ignored, if photographed.

Similarly, the first photographing device 10 is a device for photographing an area corresponding to the imaginary line (OQ) formed on the upper surface (A) of the glass substrate 1 and is disposed above the imaginary line (OQ) to be orthogonal thereto. As shown in FIG. 11, since the area photographed by the first photographing device 10 is an area (OQ) on the upper surface (A) of the glass substrate 1 to which light is radiated, only scattering caused by foreign matter attached to the upper surface (A) can be photographed by the first photographing device. However, even in the case where foreign matter is attached to an area on the lower surface (B) corresponding to the area on the upper surface (A), scattering caused by the foreign matter attached to the lower surface (B) is not photographed or provides a very dim image, which can be ignored, if photographed.

As shown in FIGS. 10 and 11, when the photographing devices 10, 20 are disposed above the imaginary lines (OP, OQ) to be orthogonal thereto, it is possible to eliminate a separate focusing lens. Further, although the apparatus according to this embodiment is illustrated as including a single first photographing device 10 and a single second photographing device 20 in the drawings, it should be understood that the apparatus may include a plurality of line CCD cameras arranged as photographing devices in the width direction of the glass substrate 1.

FIGS. 9 to 11 show a detection signal processor 40 which can more easily determine a foreign matter-attached position than the detection signal processor 40 of the other embodiment. The detection signal processor 40 shown in FIGS. 9 to 11 compares a first image and a second image respectively input from the first and second photographing devices 10, 20, and determines that foreign matter shown only on the first image is foreign matter attached to the upper surface of the glass substrate 1 and foreign matter shown only on the second image is foreign matter attached to the lower surface of the glass substrate 1.

In a modification including the photographing devices 10, 20, the photographing devices 10, 20 may be disposed at a certain angle above the upper surface of the glass substrate instead of being disposed above the upper surface thereof to be orthogonal thereto, as shown in FIG. 11. The apparatus shown in FIG. 11 has an advantage in that it has a sufficient installation space for the photographing devices 10, 20 and thus facilitates installation thereof. However, the apparatus of this embodiment also has a disadvantage in that separate focusing lenses 12, 22 are added to allow the respective photographing devices 10, 20 to have focal points on the imaginary lines (OQ, OP), respectively. In particular, when a transfer device with a low degree of precision, such as rollers, is used to transfer the glass substrate 1, the glass substrate 1 is likely to move up or down during transfer. Thus, when using the separate focusing lenses 12, 22 as shown in FIG. 11, there is a problem in that it is necessary to add an auto focusing device for accurate focusing operation.

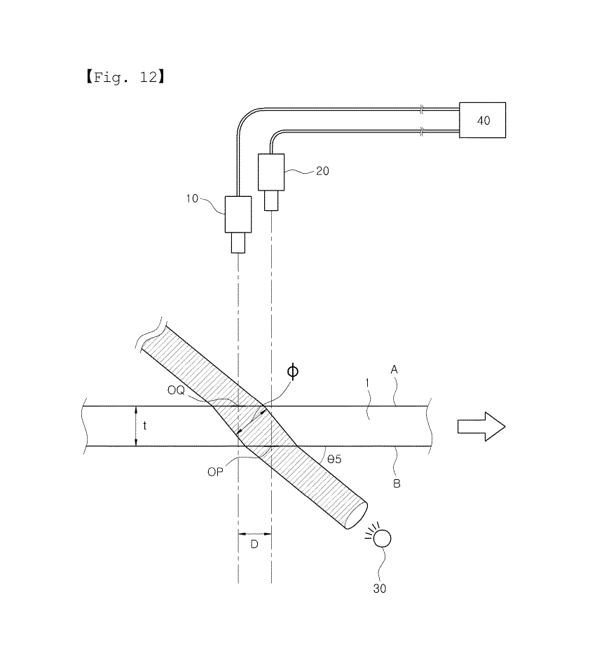

For the apparatus shown in FIGS. 9 to 11, in which the horizontal distance (D) decreases with decreasing width (D) of a light pathway from the dark field illumination system 30, foreign matter on the upper and lower surfaces can be photographed to be clearly distinguished from each other. Here, it is important that the pathway of the light emitted from the dark field illumination system 30 has a width (Φ) less than at least a thickness (t) of the glass substrate 1 while the light passes through the glass substrate 1. FIG. 12 shows a light pathway having a width which is equal to a thickness (t) of the glass substrate when light emitted from the dark field illumination system 30 passes through the glass substrate 1 under the same condition as in FIG. 11. A beam photographing area of the first photographing device 10 is indicated by OQ. As shown in this figure, it can be seen that scattering caused by foreign matter attached to the lower surface (B) can occur under the beam photographing area (OQ) of the first photographing device 10 since light emitted from dark field illumination system 30 strikes the lower surface (B) of the glass substrate. Therefore, in order to allow the first photographing device 10 to receive light scattered only by foreign matter attached to the upper surface (A), the pathway of light emitted from the dark field illumination system 30 has a width (D) less than the thickness (t) of the glass substrate 1 when the light passes through the glass substrate 1.

As described hereinabove, according to the apparatus for detecting surface defects of a glass substrate, the high test power, the advantage of a dark field optical system as well as A/B surface distinguish function may be realized together, the advantage of a bright field optical system may be realized, so that a cycle time required for the distinguish of surfaces A/B for surface defects is reduced, and an inspector has to inspect surface defects of high NG possibilities only, thereby maximizing inspection engagement.

Even though the preferred embodiments of the present invention are described and illustrated hereinabove by using particular terms, the terms are used only for clear explanation of the present invention and those skilled in the art will appreciate that various modifications and changes may be made to the embodiments and the terms of the present invention, without departing from the scope and the spirit of the invention as disclosed in the accompanying claims.

For example, even though the apparatus for detecting surface defects of a glass substrate according to the present invention as described and illustrated above comprises two photographing devices, it is also possible to mount three or more photographing devices for collecting three or more surface defect images for the distinguish of the surfaces A/B on which the surface defect exists.

Furthermore, even though the apparatus for detecting surface defects of a glass substrate according to the present invention as described and illustrated above is configured to form equal photographing areas on the top surface of the glass substrate and different photographing areas on the bottom surface, to the contrary, it is also possible to form different photographing areas on the top surface of the glass substrate and equal photographing areas on the bottom surface of the glass substrate.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. An apparatus for detecting surface defects of a glass substrate, having a dark field optical system, comprising:
a first photographing device disposed above a glass substrate for photographing first images of surface defects on the glass substrate;
a second photographing device disposed above a glass substrate for photographing second images of the surface defects on the glass substrate;
a dark field illumination system disposed below the glass substrate for serving as a dark field illumination penetrating the glass substrate towards the first photographing device and the second photographing device; and
a detection signal processor operating coordinates of a defect position on the first image and coordinates of a defect position on the second image;
wherein the first photographing device and the second photographing device form photographing areas in the shape of lines which are not parallel to at least the transferring direction of the glass substrate, form photographing areas for a top surface of the glass substrate to be overlapped by each other and form photographing areas for a bottom surface of the glass substrate differently from each other.

2. The apparatus for detecting surface defects of a glass substrate, having a dark field optical system as claimed in claim 1, wherein the detection signal processor synthesizes a third image reflecting a difference in the distance between the defect on the first image and the defect on the second image to provide the result.

3. The apparatus for detecting surface defects of a glass substrate, having a dark field optical system as claimed in claim 1, wherein the first photographing device and second photographing device form the photographing areas in the line shape to be parallel to the width direction of the glass substrate and to be symmetrical in the right and left directions with reference to a tangential line of the photographing areas for the top surface.

4. The apparatus for detecting surface defects of a glass substrate, having a dark field optical system as claimed in claim 1, wherein the dark field illumination system is structured in such a manner that a projected light passes through all of a photographing area formed on the top surface of at least the glass substrate and two photographing areas formed on the bottom surface of the glass substrate.

5. The apparatus for detecting surface defects of a glass substrate, having a dark field optical system as claimed in claim 1, wherein the first photographing device and the second photographing device are CCD (Charge-coupled device) type sensor cameras.

6. In a method for distinguishing on which surface of glass substrate surface defects are generated by using a first photographing device disposed above the glass substrate for photographing first images of surface defects on the glass substrate;
a second photographing device disposed above a glass substrate for photographing second images of the surface defects on the glass substrate; and
a dark field illumination system disposed below the glass substrate for serving as a dark field illumination penetrating the glass substrate towards the first photographing device and the second photographing device;
wherein the first photographing device and the second photographing device are disposed in such a manner that photographing areas in the line shape are formed in the width direction of the glass substrate, photographing areas for a top surface of the glass substrate are overlapped by each other, and photographing areas for a bottom surface of the glass substrate are disposed differently from each other, a method for detecting surface defects of a glass substrate, comprising the steps of:
extracting coordinates of defect position on the first image and coordinates of defect position on the second image;
generating a third image by synthesizing the first image and the second image on the basis of the extracted position coordinates; and
distinguishing which surface has the surface defects according to a difference in a distance formed by the defects corresponding to the first image and the second image in the third image.

7. The method for detecting surface defects of a glass substrate as claimed in claim 6, wherein the surface defects generated on the top surface of the glass substrate are determined if defects corresponding to the first image and defects corresponding to the second image are overlapped by each other, and
the surface defects generated on the bottom surface of the glass substrate are determined if defects corresponding to the first image and defects corresponding to the second image are separated from each other by a predetermined distance.

8. In a method for distinguishing on which surface of glass substrate surface defects are generated by using a first photographing device disposed above the glass substrate for photographing first images of surface defects on the glass substrate;
a second photographing device disposed above a glass substrate for photographing second images of the surface defects on the glass substrate; and
a dark field illumination system disposed below the glass substrate for serving as a dark field illumination penetrating the glass substrate towards the first photographing device and the second photographing device;
wherein the first photographing device and the second photographing device are disposed in such a manner that photographing areas in the line shape are formed in the width direction of the glass substrate, photographing areas for a top surface of the glass substrate are overlapped by each other, and photographing areas for a bottom surface of the glass substrate are disposed differently from each other,
a method for detecting surface defects of a glass substrate, comprising the steps of:
extracting coordinates of positions of defects on the first image and coordinates of positions of defects on the second image; and
distinguishing the surface defects generated on the top surface of the glass substrate if defects corresponding to the first image and defects corresponding to the second image are equal to each other, and the surface defects generated on the bottom surface of the glass substrate if defects corresponding to the first image and defects corresponding to the second image are different from each other.

9. An apparatus for detecting surface defects on a glass substrate having a dark field optical system, the apparatus comprising:
a dark field illumination system disposed below a glass substrate and emitting light upwards such that the emitted light is incident on an imaginary line (OP) approximately vertical to a transfer direction on a lower surface of the glass substrate, refracted in a thickness direction of the glass substrate, and then passes through an imaginary line (OQ) approximately vertical to the transfer direction on an upper surface of the glass substrate;
a first photographing device photographing an area of the imaginary line (OQ) formed on the upper surface of the glass substrate;
a second photographing device photographing an area of the imaginary line (OP) formed on the lower surface of the glass substrate; and
a detection signal processor determining which surface foreign matter is attached to among the upper and lower surfaces of the glass substrate by comparing images input from the first and second photographing devices.

10. The apparatus as claimed in claim 9, wherein an incident angle of the light with respect to a normal vector of the lower surface of the glass substrate is greater than 45° and less than 85° when the light emitted from the dark field illumination system is incident on the lower surface of the glass substrate.

11. The apparatus as claimed in claim 9, wherein at least one of the first and second photographing devices is disposed above the area of the imaginary line (OQ) on the upper surface of the glass substrate to be orthogonal thereto or above the area of the imaginary line (OP) on the lower surface of the glass substrate to be orthogonal to.

12. The apparatus as claimed in claim 9, wherein a pathway of the light emitted from the dark field illumination system has a width (Φ) less than a thickness (t) of the glass substrate when passing through the glass substrate.
